(19) United States
(12) Patent Application Publication
(10) Pub. No.: US 2003/0067962 A1
(43) Pub. Date: Apr. 10, 2003

(54) Determining cross-correlation between spreading sequences

(76) Inventor: Daniel Yellin, Raanana (IL)

Correspondence Address: Timothy N. Trop, TROP, PRUNER & HU, P.C., STE 100, 8554 KATY FWY, HOUSTON, TX, 77024-1805, US

(21) Appl. No.: 09/974,921

(22) Filed: Oct. 10, 2001

(51) Int. Cl. H04K 1/00

(52) U.S. Cl. 375/130

(57) ABSTRACT

The cross-correlation between spreading sequences in a CDMA cellular telephone may be determined by generating a pilot code and a channel code. The pilot and channel code are passed to an exclusive OR gate that indicates to a binary counter the number of times that the codes are the same or different. This information may then be utilized to determine the cross-correlation values.

### BACKGROUND

The present invention relates to spread spectrum communication systems generally and to determining cross-correlation values in mobile handsets of such communication systems in particular.

A conventional spread spectrum signal can be viewed as the result of mixing a narrowband information-bearing signal i[t] with an informationless wideband “spreading” signal p[t]. If Bᵢ and Bₚ denote the bandwidths of i[t] and p[t], respectively, then the “processing gain” available to the receiver is Bₚ/B₁. The receiver synchronizes the incoming signal to a locally generated version p₀[t] of p[t] and mixes the received signal with p₀[t], thereby removing p[t] from the signal and “collapsing” the signal to the “information bandwidth” Bᵢ.

The spreading signal p[t] is typically a coding sequence of some kind, such as a pseudo-random code. In cellular code division multiple access (CDMA) systems, the code is an M-sequence or a Gold Sequence which has good “noise like” properties yet is very simple to construct.

For example, in the IS-95 standard for cellular communication, the forward channel (base to mobile units) employs, as a spreading code, the product of a 64 chip Walsh code (aimed at separating up to 64 different users per base) and a periodic pseudorandom noise (PN) sequence (aimed at separating the different bases). See TIA/EIA IS-95A “Mobile System-Base Station Compatibility Standard for Dual-Mode Wideband Spread Spectrum Cellular System” Telecommunication Industry Association. Thus, the spreading signal p[t] for each user is its Walsh code combined with the current 64 chips of the PN sequence of its base station.

In a number of instances, a cross-correlation between signature sequences needs to be calculated. One such example is in connection with the cancellation of pilot channel interference. See, for example, U.S. Pat. No. 6,034,986 to Yellin. However, in a wide variety of other applications in connection with spreading sequences, cross-correlation between signature values needs to be computed. Other examples of multi-user detection techniques that involve cross-correlation values are set forth in “Multi-User Detection” by S. Verdu, Cambridge University Press, 1998 and the references therein.

In a variety of multi-user detection techniques, there is a need for a better way to calculate the cross-correlation between signature sequences. In particular, there is a need for ways to calculate cross-correlation values that may be implemented in efficient hardware designs, for example.

### BRIEF DESCRIPTION OF THE DRAWINGS

FIG. 1 is a schematic depiction of hardware for calculating cross-correlation terms in accordance with one embodiment of the present invention;

FIG. 2 is a schematic depiction of hardware for calculating cross-correlation terms in accordance with another embodiment of the present invention; and

FIG. 3 is a schematic depiction of hardware for calculating cross-correlation terms in accordance with one embodiment of the present invention.

### DETAILED DESCRIPTION

The cross-correlation between the spreading sequence S_{d}(m) to the spreading sequence S₀(m) is given by the following Equation 1:

$$R ( α , n ) ≡ {\sum }_{l = 1}^{SF} {S}_{d} ( l + n \cdot SF ) * \cdot {S}_{0} ( l + n \cdot SF - α ) \qquad Equation 1$$

where S_{d}(m) stands for the “m”th chip of the spreading sequence associated with one user, S₀(m) stands for the “m”th chip of the spreading sequence associated with another user, SF is the spreading factor, and (·)* stands for the complex conjugation of the bracketed term.

The cross-correlations appearing in Equation 1 may be calculated using the assumption that the spreading sequences are Binary Phase-Shift Keying (BPSK) or Quadrature Phase-Shift Keying (QPSK) modulated (as is the case in all CDMA cellular standards).

Assuming the more general case of QPSK spreading, and breaking Equation 1 into its real and imaginary parts, immediately yields:

$$\begin{matrix}Re \{ R ( α , n ) \} ≡ {\sum }_{l = 1}^{SF} Re \{ {S}_{d} ( l + n \cdot SF \} \cdot Re \{ {S}_{0} ( l + n \cdot SF - α ) \} + \\ {\sum }_{l = 1}^{SF} Im \{ {S}_{d} ( l + n \cdot SF ) \} \cdot Im \{ {S}_{0} ( l + n \cdot SF - α ) \}\end{matrix} \\ \begin{matrix}Im \{ R ( α , n ) \} ≡ {\sum }_{l = 1}^{SF} Re \{ {S}_{d} ( l + n \cdot SF ) \} \cdot Im \{ {S}_{0} ( l + n \cdot SF - α ) \} - \\ {\sum }_{l = 1}^{SF} Im \{ {S}_{d} ( l + n \cdot SF ) \} \cdot Re \{ {S}_{0} ( l + n \cdot SF - α ) \}\end{matrix} \qquad Equation 2$$

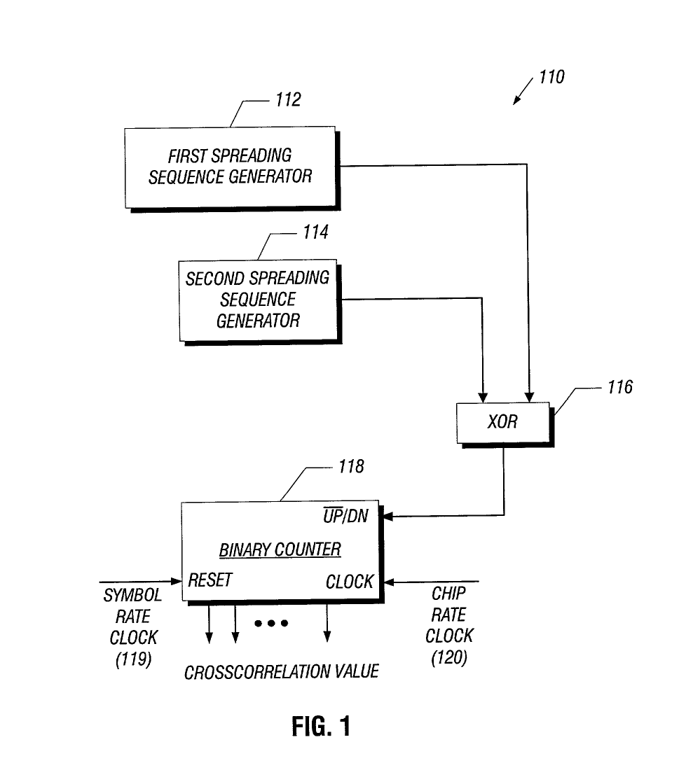

Now, each of the above four summation terms can be efficiently calculated via the logic circuit 110 depicted in FIG. 1. As an example examine the first sum in Equation 2:

$${\sum }_{l = 1}^{SF} Re \{ {S}_{d} ( l + n \cdot SF \} \cdot Re \{ {S}_{0} ( l + n \cdot SF - α ) \} \qquad Equation 3$$

The result of the summation in Equation 3 equals the number of times the two spreading chips are identical minus the number of times they differ. With the binary representation of the two spreading sequences, this equation may be implementable via a single XOR gate 116, whose output drives a binary counter 118 that receive the chip rate clock 120. The end result is that the binary counter 118 counts the number of times the corresponding (binary valued) chips of the two spreading sequences were identical minus the number of times they differed. In one embodiment, the counter 118 is an up/down counter that counts up, for example, for sequences that are identical and down for sequences that differ. Thus, the output of the counter 118 is a cross-correlation value.

The counter 118 is cleared once every SF chips via the symbol rate clock 119, since one symbol equals SF chips. Clearing the counter 118 guarantees that the summation is appropriately performed over SF chips. Altogether, four blocks of the type presented in FIG. 1 may be used to calculate the four different elements of Equation 2.

If BPSK spreading is used, then all the imaginary values appearing in Equation 2 are zero, and Equation 2 collapses to the following

$$R ( α , n ) ≡ {\sum }_{l = 1}^{SF} {S}_{d} ( l + n \cdot SF \} \cdot {S}_{0} ( l + n \cdot SF - α )$$

which can be efficiently implemented with the logic circuit 110 using single counter.

In a multi-user detection embodiment, the first spreading sequence generator 112 may be the dedicated channel of one user and the second spreading sequence generator 114 may be the dedicated channel of another user.

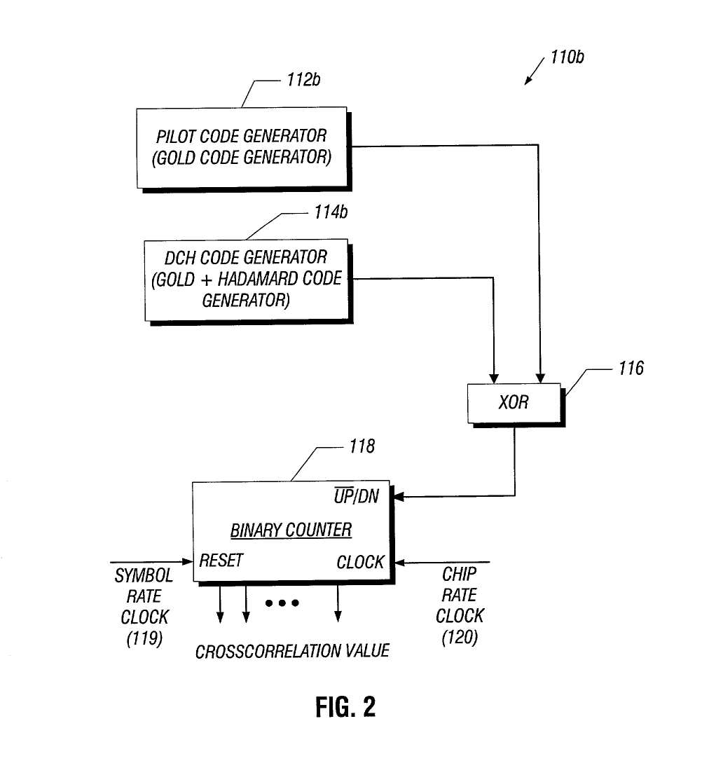

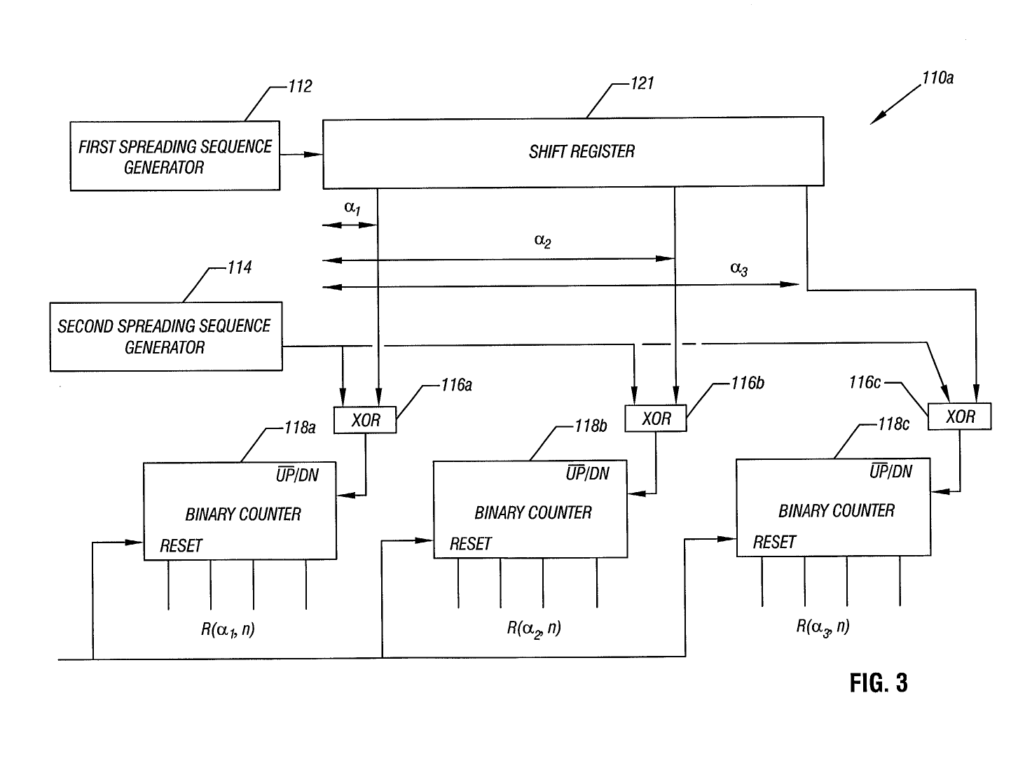

In one embodiment of this invention, shown in FIG. 2, the cross-correlation that needs to be calculated is between the signature sequence of a desired user to the signature sequence of a pilot channel. In this case, the symbols k, n, m, qᵤₛₑᵣ(), qₚᵢₗₒₜ, and N in Equation 2 in U.S. Pat. No. 6,034,986, are −α, n, l−1, S_{d}(), S₀() and SF, respectively, in Equation 1. The constant 1/2N in Equation 2 in U.S. Pat. No. 6,034,986 is irrelevant for purposes of Equation 1. The pilot code generator 112b generating the signature sequence associated with the pilot channel may be a Gold code generator, for example, for the WCDMA cellular communication standard, and a maximal length shift register (MLSR), for example, in the case of the IS-95 and CDMA-2000 cellular standards. The generator 112b outputs are two streams of binary chips corresponding to the real and imaginary binary versions of the corresponding pilot spreading sequence. These outputs may be delayed, via a shift register 121 in one embodiment, depicted in FIG. 3, to generate the relative delay of α chips appearing in Equations 1 and 2.

Alternatively, the pilot spreading sequence can be generated with the desired delay thus avoiding the need for the additional shift register. However, with regard to pilot cancellation and/or multi-user detection, multiple cross-correlation values are used, and the latter approach would use multiple pilot code generators. Therefore, the implementation in FIG. 2, that uses a single pilot code generator 112b to calculate several cross-correlation values, may be more efficient.

The dedicated channel (DCH) code generator, generating the signature sequence of the desired user, 114b is similar to the pilot code generator 112b with an additional Walsh/Hadamard code generator and with the specific code corresponding to the dedicated channel (user) of interest.

In another embodiment, a multi-user receiver is used and the cross-correlation between the signature sequences of two arbitrary users (that may or may not belong to different base stations) needs to be calculated. In this case, the proposed invention is also applicable by letting S_{d}(m) denote the spreading sequence (or signature) of one of the users and S₀(m) denote the spreading sequence of the other.

For completeness, an example of one common algorithm for translating from binary to BPSK or from binary to QPSK is given by the following equations:

A_{BPSK}=1−2·A_{BINARY}

and

A_{QPSK}=[1−2·Re{A_{BINARY}}]+j·[1−2·Im{A_{BINARY}}]

Thus, if \tilde{S}₀(m) stands for the binary outputs of one code generator 112, then:

S₀(m)=[1−2·Re{\tilde{S}₀(m)}]+j·[1−2·Im{\tilde{S}₀(m)}]

and similarly if \tilde{S}_{d}(m) stands for the binary output of the other code generator 114, then:

S_{d}(m)=[1−2·Re{\tilde{S}_{d}(m)}]+j·[1−2·Im{\tilde{S}_{d}(m)}]

Of course, other algorithms may also be used.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
generating a first spreading sequence;
generating a second spreading sequence; and
determining the number of times that said first and second spreading sequences are the same.

2. The method of claim 1 including determining the number of times that spreading sequences are different.

3. The method of claim 2 including applying the first and second spreading sequences to an exclusive OR gate.

4. The method of claim 3 including applying the output of an exclusive OR gate to a binary counter.

5. The method of claim 4 including applying the output of said exclusive OR gate to an up/down binary counter.

6. The method of claim 1 including determining a cross-correlation value.

7. The method of claim 6 including determining a cross-correlation value for each of four cross-correlation terms.

8. The method of claim 7 including converting binary to a Binary Phase-Shift Keying.

9. The method of claim 7 including converting binary to a Quadrature Phase-Shift Keying.

10. The method of claim 1 including generating a spreading sequence using a Gold code generator.

11. The method of claim 1 including generating a channel code using a Gold and Hadamard code generator.

12. A circuit comprising:
a first spreading sequence generator;
a second spreading sequence generator; and
a device to determine the number of times that said first and second spreading sequence are the same.

13. The circuit of claim 12 wherein said device determines the number of times that said first and second spreading sequences are different.

14. The circuit of claim 13 wherein said device includes an exclusive OR gate coupled to said generators.

15. The circuit of claim 14 wherein said device includes a binary counter coupled to said exclusive OR gate.

16. The circuit of claim 15 wherein said binary counter is an up/down binary counter.

17. The circuit of claim 12 wherein said device determines a cross-correlation value between the first and second spreading sequences.

18. The circuit of claim 17 wherein said device determines a cross-correlation value for each of four cross-correlation terms.

19. The circuit of claim 18 wherein said device converts binary to Binary Phase-Shift Keying.

20. The circuit of claim 18 wherein said device converts binary to Quadrature Phase-Shift Keying.

21. The device of claim 12 wherein said first spreading sequence generator includes a Gold code generator.

22. The device of claim 12 wherein said second spreading sequence generator includes a Gold and Hadamard Code Generator.

23. An apparatus comprising:
a pilot channel multiple access interference cancellation mechanism; and
a circuit to calculate the cross-correlation value between spreading sequences, said circuit including a pilot code generator and a channel code generator, and a device to determine the number of times said pilot and channel codes are the same.

24. The apparatus of claim 23 wherein said apparatus is a cellular telephone.

25. The apparatus of claim 23 wherein said device includes an exclusive OR gate coupled to said pilot code generator and said channel code generator, and a binary counter coupled to said exclusive OR gate.

26. The apparatus of claim 23 wherein said pilot code generator is a Gold code generator.

27. The apparatus of claim 23 wherein said channel code generator includes a Gold and a Hadamard code generator.

28. The apparatus of claim 23 wherein said device converts binary to Binary Phase-Shift Keying.

29. The apparatus of claim 23 wherein said device converts binary to Quadrature Phase-Shift Keying.

30. The apparatus of claim 23 wherein said device determines the number of times that the pilot and channel codes are different.
